(19) United States
(12) Patent Application Publication
(10) Pub. No.: US 2021/0236991 A1
(43) Pub. Date: Aug. 5, 2021

(54) REVERSE OSMOSIS DRINKING WATER SYSTEM WITH DEDICATED POWERED FAUCET

(71) Applicant: CULLIGAN INTERNATIONAL COMPANY, Rosemont, IL (US)

(72) Inventors: Tedd M. SCHNEIDEWEND, Glen Ellyn, IL (US); Bill LATHOURIS, Arlington Heights, IL (US); Christopher G. HARRIS, Chicago, IL (US); Chia H. KUNG, Buffalo Grove, IL (US); Adam SLOMA, Arlington Heights, IL (US); David J. WEST, Chicago, IL (US)

(21) Appl. No.: 17/165,591

(22) Filed: Feb. 2, 2021

Related U.S. Application Data
(60) Provisional application No. 62/969,506, filed on Feb. 3, 2020.

(51) Int. Cl. B01D 61/10; C02F 1/00; C02F 1/44; B01D 61/02; B01D 61/04; B01D 61/08

(52) U.S. Cl. CPC B01D 61/10; C02F 1/003; C02F 1/441; B01D 61/025; B01D 61/04; B01D 61/08; B01D 2313/50; C02F 2201/004; C02F 2307/06; B01D 2311/04; B01D 2311/2649; B01D 2313/18; B01D 2313/13; C02F 2201/005

(57) ABSTRACT

An air gap adapter for use with a water treatment faucet constructed and arranged for being mounted in a standard countertop faucet opening. The adapter includes an adapter base with an underside, defining a base throughbore for a standard faucet inlet nipple, having an RO retentate inlet port and a separate RO retentate outlet port. A cone insert has a platform covering at least a portion of the base, and a cone formation vertically projecting from the platform and being in fluid communication with the inlet port. An outlet opening is on the cone formation in fluid communication with the outlet port. An adapter cover disposed over the cone insert and the base includes a cone cover portion and a base cover portion, as well as a cover throughbore in registry with the throughbore. The adapter is constructed and arranged to be optionally mounted to a countertop with the faucet.

### RELATED APPLICATION

The present application is a Non-Provisional of, and claims priority under 35 U.S.C. 119 from, U.S. Provisional Application Ser. No. 62/969,506 filed Feb. 3, 2020, the contents of which are incorporated by reference herein.

### BACKGROUND

The present invention relates to Reverse Osmosis (RO) treatment systems used for treating drinking water, and more specifically to an enhanced RO treatment system the features a dedicated faucet configured for providing an electrical power source and display information about the system.

RO water treatment systems are known in the art, and exemplary systems are described in U.S. Pat. Nos. 7,338,595 and 9,616,388 which are incorporated by reference. In conventional water treatment systems, incoming potable water is further treated to remove suspended particles, referred to as Total Dissolved Solids (TDS), unwanted chemicals, unpleasant taste, excessive minerals and the like. Such treatment systems typically include at least one activated carbon filter connected in series to an RO unit. The RO unit includes a fine pore membrane for performing high level filtration. Incoming water is fed at high pressure through the membrane, and solid retentate captured by the membrane is removed before the treated water is stored in a storage tank and sent to drain. Employing an RO unit in a water treatment system reduces the TDS concentration level to between 0-50 ppm (0-50 mg/L).

Often, water treatment systems including RO units employ designated faucets that are mounted on the countertop closely adjacent a main faucet. The designated faucet is connected directly to an outlet of the water treatment system, typically mounted in a cabinet under the sink. Since the RO unit is connected to a drain line, an air gap or vent is needed to prevent back flow to the treatment unit. According to US plumbing codes, an air gap must be located above the flood plane, which in a residential RO unit with the RO drain in communication with the standard sink drain, is the highest point of the sink basin where water could overflow.

Conventional RO faucets integrate the air gap directly into the faucet design, such as by adding a designated port or air vent into the faucet housing or mounting plate. However, it has been found that such air gaps are not needed for all installations, yet the addition of the air gap is costly in design and manufacturing effort.

In addition, it is common for conventional water treatment systems to increasingly feature electronic sensors, controls and operational status indicators for the operators/consumers. Traditionally, these systems are connected to a power supply located under the counter or sink adjacent to a garbage disposal. However, in some countries, building practices do not routinely provide power access under the sink. Accordingly, there is a need for an alternate source of power for the electronic features of modern water treatment systems.

### SUMMARY

The above-listed need is met or exceeded by the present water treatment supplemental or designated faucet, which features the provision of an air gap adapter as an installation option. Thus, the installer can determine whether or not to include the air gap when the faucet is being installed. In addition, the same faucet design is usable for both standard water filtration and RO systems.

A feature of the present designated faucet is that the air gap option utilizes the standard faucet mounting aperture in the countertop. No additional holes need to be drilled into the faucet or countertop for adding the air gap option.

Another feature of the present RO faucet is a connection to an external power source, which, through an internal connection, is also electrically connected to an under counter water treatment system for powering/recharging the treatment system without access to an under counter outlet. It is contemplated that the connection at the faucet is either directly connected or hard wired, or alternately uses induction coils, with a first coil in the faucet and a second coil in the charging cord.

Still another feature of the present RO faucet is that it is usable with an RO system including enhanced electronic sensing and control features. For example, electronically-controlled solenoid valves are optionally connected into the system so that the user has the option of adjusting the following parameters: fill time based on water quality, tank fill rate based on user demand, water efficiency based on water quality, tank fill based on inlet pressure, and the like.

In one embodiment, solenoid valves are positioned in the system in the main water feed line upstream and downstream of a pre carbon filter so as to selectively isolate the carbon filter and also the RO membrane and an associated pre-tank filter. Further, another solenoid valve is optionally positioned in the drain line of the RO unit for control of the flow of retentate to drain. Additional valves, as well as sensors, meters and associated processors are also contemplated.

More specifically, an air gap adapter is provided for use with a water treatment faucet constructed and arranged for being mounted in a standard countertop faucet opening. The adapter includes an adapter base with an underside, defining a base throughbore for a standard faucet inlet nipple, having an RO retentate inlet port and a separate RO retentate outlet port. A cone insert has a platform covering at least a portion of the adapter base, and a cone formation vertically projecting from the platform and being in fluid communication with the inlet port. An outlet opening is on the cone formation in fluid communication with the RO retentate outlet port. An adapter cover disposed over the cone insert and the base includes a cone cover portion and a base cover portion, as well as a cover throughbore in registry with the base throughbore. The adapter is constructed and arranged to be optionally mounted to a countertop with the faucet.

In an embodiment, the inlet port has an associated inlet flow channel, and the outlet port having an associated outlet flow channel in the adapter base. Also, in one embodiment, the cone insert platform covers inlet flow channel and the outlet flow channel A flow directing formation is optionally provided on an exterior of the cone formation in fluid communication with an outlet opening in the cone formation and also with an outlet flow channel.

In another embodiment, an air gap adapter is provided for use with a water treatment faucet constructed and arranged for being mounted in a standard countertop faucet opening. The adapter includes an adapter base with an underside, defining a base throughbore for a standard faucet inlet nipple, having an RO retentate inlet port and a separate RO retentate outlet port. The inlet port has an associated inlet flow channel, and the outlet port has an associated outlet flow channel in the adapter base. A cone insert has a platform covering at least a portion of the adapter base including the inlet flow channel and the outlet flow channel, and a cone formation vertically projects from the platform and is in fluid communication with the inlet flow channel. A flow directing formation on an exterior of the cone formation is in fluid communication with an outlet opening in the cone formation and also with the outlet flow channel. An adapter cover includes a cone cover portion and a base cover portion, as well as a cover throughbore in registry with the base throughbore.

In one embodiment, a first seal is configured for isolating the inlet flow channel from the outlet flow channel, and a second seal isolates the flow directing formation from the platform. In another embodiment, the adapter cover includes a depending skirt for enveloping a peripheral edge of the base. In an embodiment, the RO retentate inlet port has a shorter axial length than the RO retentate outlet port. In an embodiment, the inlet channel is adjacent the outlet flow channel in the base.

In still another embodiment, a water treatment faucet is provided, being configured for use with a standard water faucet mounted in operational relationship to a sink and located on a countertop. The water treatment faucet includes a faucet base configured for mounting to the countertop, and having a first electrical connector connected to a remote power source, and a second electrical connector connected to a water treatment system located underneath the countertop. It is preferred that the first electrical connector is electrically connected to the second electrical connector. In a preferred embodiment, the first electrical connector is a primary induction coil; and the second electrical connector is a secondary induction coil located in operational proximity to the primary induction coil. Alternately, the first electrical connector is directly electrically connected to the second electrical connector.

In a still further embodiment, a water treatment system is provided, including at least one prefilter, at least one RO membrane unit, at least one pre-tank filter and a treated water storage tank, all of the above being connected by a water feed line. Also included in the system is at least one solenoid valve being connected between an inlet and at least one of the at least one filters, between the at least one RO membrane unit and said storage tank for controlling flow in the water feed line.

In an embodiment, the at least one solenoid valve includes a first solenoid valve connected to said water feed line before the at least one prefilter. In another embodiment, the at least one solenoid valve includes a second solenoid valve connected to the water feed line between the at least one prefilters and the at least one RO membrane unit. In an embodiment, the second solenoid valve has an inlet connected to the water feed line between the at least on prefilter and the at least one RO membrane unit, and a solenoid valve outlet connected to the water feed line between the at least RO membrane unit and the RO storage tank.

In an embodiment, the system further includes a pretank filter connected to the water feed line between the at least one RO membrane unit and the second solenoid valve outlet. In another embodiment, the at least one solenoid valve includes a third solenoid valve connected to a drain line connected to the at least one RO membrane unit.

### BRIEF DESCRIPTION OF THE DRAWINGS

FIG. 1 is a fragmentary perspective view of a water treatment faucet equipped with the present air gap adapter;

FIG. 1A is a fragmentary enlarged view of FIG. 1;

FIG. 2 is a top perspective exploded view of the present air gap adapter;

FIG. 3 is a fragmentary bottom perspective view of the base of the present air gap adapter;

FIG. 4 is a fragmentary top perspective view of the base of the present air gap adapter;

FIG. 5 is a fragmentary bottom perspective of the present air gap adapter showing the cone formation;

FIG. 6 is a fragmentary top perspective view of the present air gap adapter showing the cone formation and the base;

FIG. 7 is a fragmentary vertical cross-section of the present air gap adapter showing a first flow pattern;

FIG. 8 is the fragmentary vertical cross-section of FIG. 7 showing a second flow pattern;

FIG. 9 is a front perspective view of the present water treatment system showing a powered water treatment faucet;

FIG. 10 is a schematic of an alternate embodiment of the system of FIG. 9; and

FIG. 11 is a schematic of another embodiment of the present water treatment system.

### DETAILED DESCRIPTION

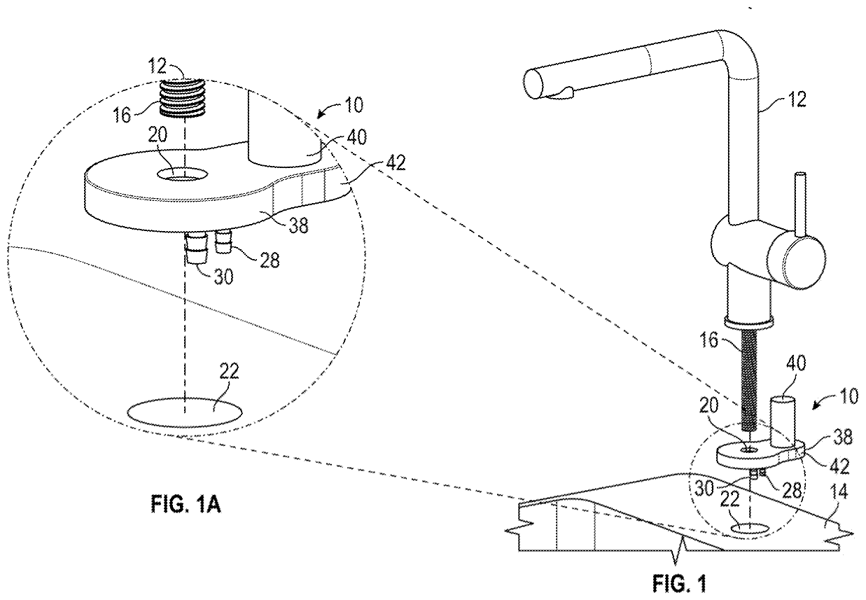

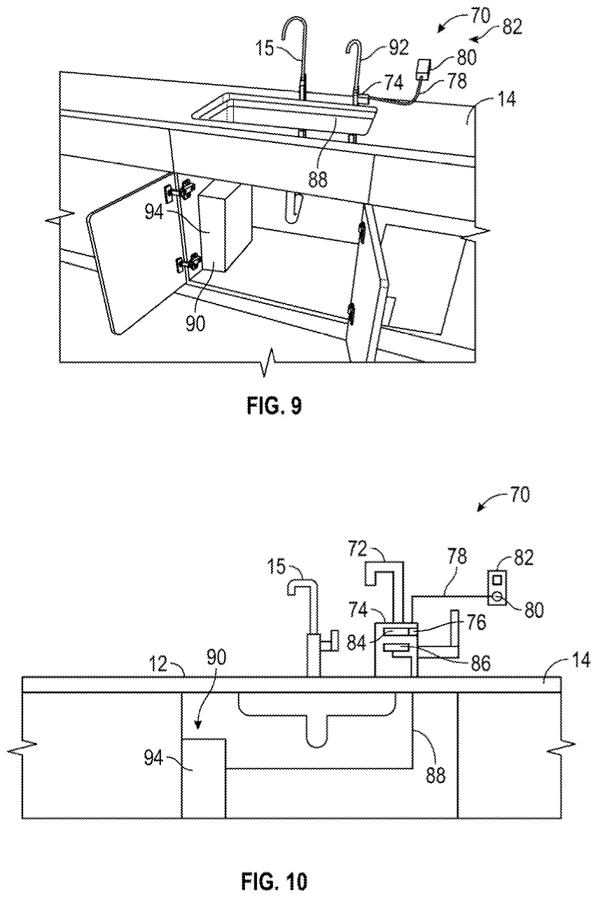

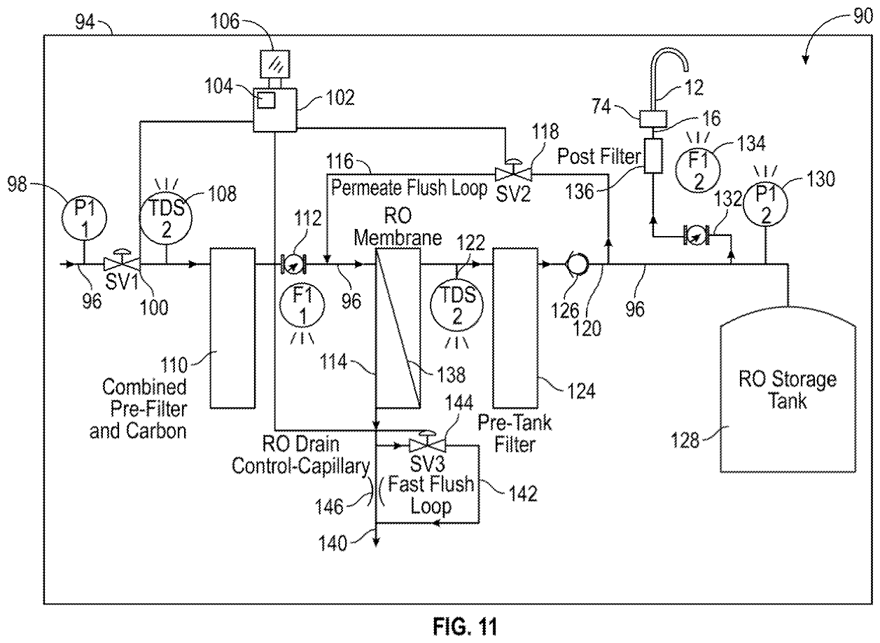

Referring now to FIGS. 1 and 1A, the present air gap adapter, generally designated 10, is shown mounted between a designated water treatment faucet 12 and a corresponding substrate 14, either a countertop or a lip of a sink, as is well known in the art. As is well known, such faucets 12 are auxiliary to a main faucet 15 (FIG. 9) and are configured for dispensing only treated drinking water. Included on the faucet 12 is a depending inlet conduit 16 which is connected to water feed lines located below the substrate 14 as is well known in the art. A feature of the present air gap adapter 10 is that it is optionally provided with the faucet 12, in situations where the faucet is connected to a Reverse Osmosis (RO) treatment system (FIG. 11). In such applications, the RO retentate water is sent to drain, but must be provided with an approved backflow prevention device, in this case an air gap adapter, to comply with local plumbing codes. As such, the air gap adapter 10 features a throughbore 20 dimensioned to slidingly accommodate the inlet conduit 16. Thus, when employed, the air gap adapter 10 does not require the creation of any additional holes in the substrate 14 aside from a standard auxiliary faucet opening 22.

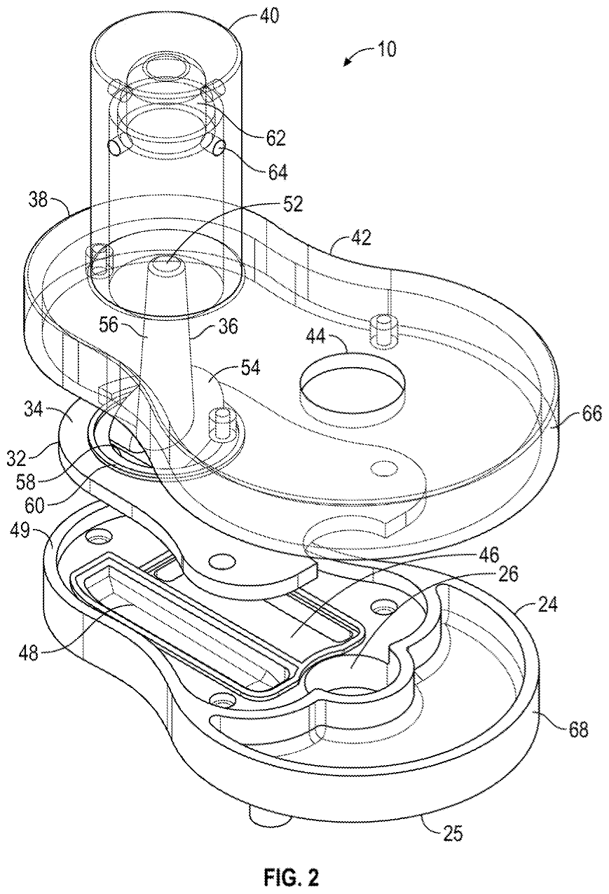

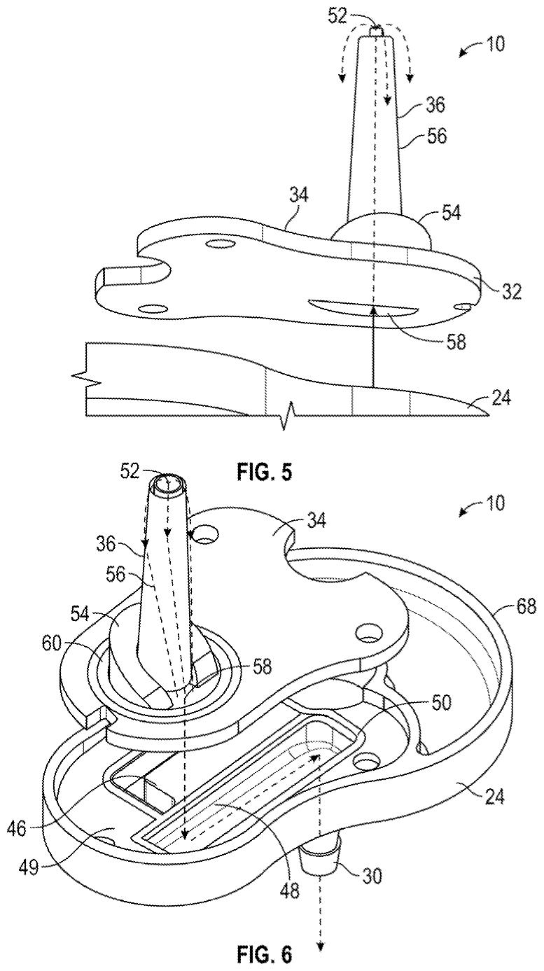

Referring now to FIGS. 2-8, the present air gap adapter 10 includes three main components. First, an adapter base 24 is provided with an underside 25, defining a base throughbore 26 in registry with the throughbore 20, the base having an RO retentate inlet port 28 and a separate RO retentate outlet port 30. Next, a cone insert 32 having a platform 34 covering at least a portion of the adapter base 24, and a cone formation 36 vertically projecting from the platform and being in fluid communication with the inlet port 26. A last component of the adapter 10 is an adapter cover 38 including a cone cover portion 40 and a base cover portion 42, as well as a cover throughbore 44 in registry with the base throughbore 26 and the throughbore 20.

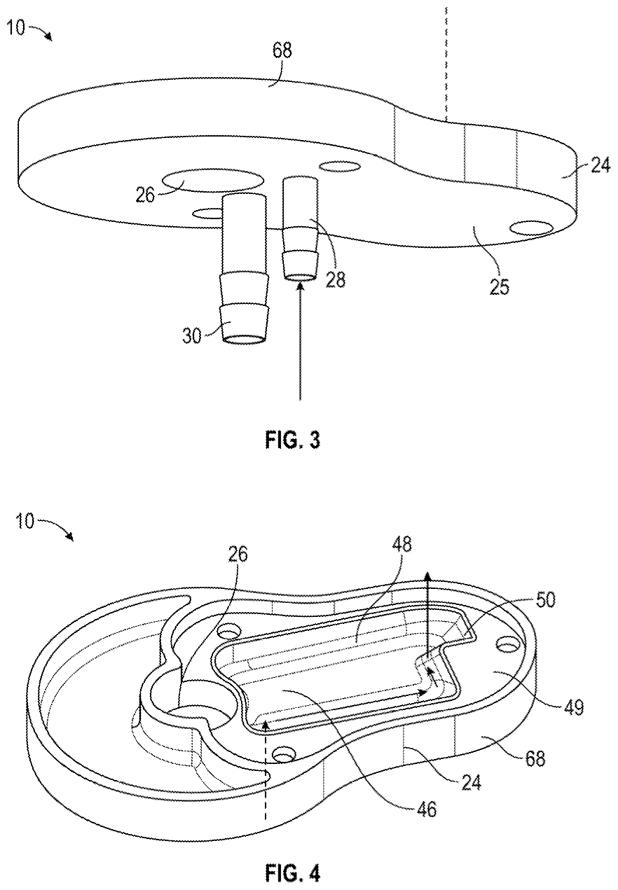

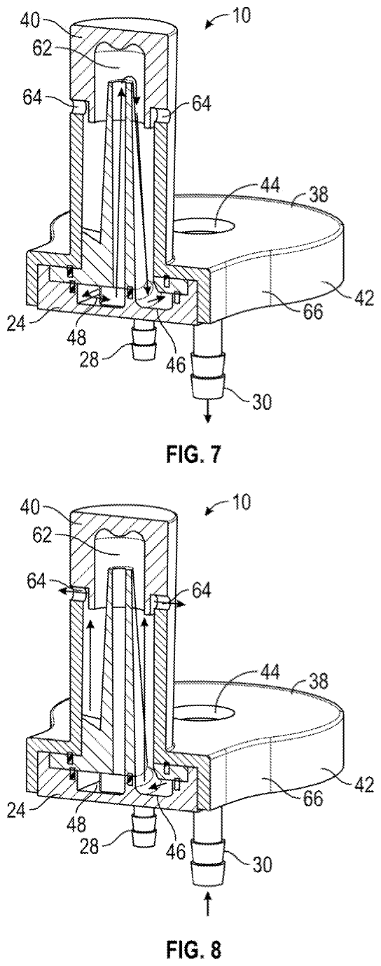

As seen in FIG. 1, when the optional air gap adapter 10 is employed, the RO retentate inlet and outlet ports 28, 30 easily coexist in the standard countertop opening 22 with the faucet inlet conduit 16. As seen in FIGS. 3 and 7, the RO retentate inlet port 28 has a shorter axial length than the RO retentate outlet port 30. This construction facilitates connection of the appropriate conduits by the installer, and reduces misconnections.

Returning now to FIGS. 2, 4 and 6, on the base 24, the inlet port 28 has an associated inlet flow channel 46 for receiving the water flow from the RO retentate that is targeted to drain. Also, the RO retentate outlet port 30 has an associated outlet flow channel 48 that receives water from the cone formation 36 and sends the water to the outlet flow channel, then to the outlet port 30, from where it is sent to drain. As seen in FIG. 4, the channels 46, 48 are preferably adjacent each other in the base, 24, and more preferably are in contacting, parallel arrangement with each other.

Regarding the cone insert 32, the platform 34 covers at least a portion of the adapter base 24 including the inlet flow channel 46 and the outlet flow channel 48. It will be seen in FIGS. 2 and 6 that the platform 34 nests in a recess 49 in the adapter base 24. In the preferred embodiment, the platform 34 is irregularly shaped to promote proper positioning in the recess 49. It is contemplated that the specific shape of the platform 34 may vary to suit the application. A first seal member 50, preferably an O-ring style gasket or the like is fitted to the base 24 and is constructed and arranged for maintaining separation between the fluid flows in the channels 46, 48. Upon assembly, the adapter cover 38 covers and closes off the two channels 46, 48 compressing the first seal member 50.

On an apex of the vertically projecting, hollow cone formation 36, an opening 52 receives water from the inlet flow channel 46, which then drips down the formation until it reaches a flow directing formation 54 on an exterior 56 of the cone formation. In the preferred embodiment, the flow directing formation 54 is generally helically shaped, and directs the flow of water to an outlet opening 58 at a bottom of the cone formation 36 near the platform 38. The outlet opening 58 is in fluid communication with the outlet flow channel 48 and ultimately also in communication with the RO retentate outlet port 30.

Referring again to FIGS. 2 and 6, a cone formation seal 60, preferably an O-ring or the like, is disposed in the platform 34 and is constructed and arranged for isolating the flow directing formation 54 and the outlet opening 58 from the platform to prevent spillage.

Referring now to FIGS. 2, 7 and 8, the adapter cover 38 includes the cone cover portion 40 that defines an air space 62 around the cone formation 36, and also features at least one preferably laterally-opening vent 64. The normal flow pattern is depicted in FIG. 7. In the event the sink drain is clogged (FIG. 8), dirty water will back up into the air space 62, but flows out of the vents 64. The distance between the counter top (or flood plan) and the air space 62 is designed to be 1″ to meet plumbing codes. With this configuration, dirty water cannot reach the RO membrane. Also, the cover 38 includes a skirt 66 depending from the base cover portion 42 and enveloping a peripheral edge 68 of the base 24.

Referring now to FIGS. 9 and 10, another embodiment of the present RO water treatment system is generally designated 70. Components shared with the adapter 10 are designated with identical reference numbers. A water treatment faucet 72 is configured for optionally being mounted with the air gap adapter 10 in similar fashion to the treatment faucet 12. While in FIG. 10 the water treatment faucet 72 is shown larger than the standard faucet 15, this is for illustration purposes only, and in reality, as is known in the art, the standard faucet is the larger unit. In addition, the faucet 72 is provided with a faucet base 74 dimensioned for being supported on the countertop 14. Included on the faucet base 74 is an electronic receptacle 76 that is connected to a cable 78 connected to a transformer 80 which is plugged into a standard wall outlet 82, which in some cases is a GFI-style, as required by local building codes due to the close proximity to water.

Referring now to FIG. 10, inside the faucet base 74 is a first electrical connector 84, in the preferred embodiment a primary induction coil connected to conventional power supply circuitry (not shown) as is known in the art and powered through connection to the wall outlet 82. Connected to the first connector 84 is a second connector 86, in the preferred embodiment a secondary induction coil located in operational proximity to the primary induction coil for making an electrical connection across a space between the two coils. The second electrical connector 86 is also connected via a cable 88 or wirelessly, to a water treatment system, generally designated 90, which will be described in greater detail below. In addition to various filters, RO units, treatment tanks, and the like, included in the water treatment system 90 are various monitors, sensors, controls and/or indicators that require electrical power. The present faucet 74 with electrical connection capability is especially useful in installations where there is no electrical outlet under the countertop 14.

Referring now to FIG. 9, an alternate embodiment to the faucet 72 in FIG. 10 is generally designated 92. Components shared with the faucet 72 are designated with identical reference numbers. A main difference between the faucets 72 and the faucet 92 is that in the latter, instead of the induction coils used for the connectors 84, 86, the connectors are standard hard-wired connections, so that power is directly electrically connected and transferred from the outlet 82 to the water treatment system 90.

Referring now to FIG. 11, the water treatment system 90 is shown in greater detail. Located within a housing 94 water feed line 96 is connected to an incoming cold water inlet (not shown) that is standard in any residence or business establishment. A first pressure sensor 98 monitors water pressure in the feed line 96. A first solenoid valve 100 is powered by the cable 88 and is controlled by a control module 102, preferably including a programmable processor 104 and a graphic user interface (GUI) 106 facilitating user input and control over the water treatment system 90. The system 90 has the ability to connect wirelessly to the Cloud to both send and receive data. This allows the user to receive updates on the system 90 for leak detection, water quality readings, water usage, low battery, and filter cartridge replacement, among other parameters. The user sends information to change the state of the system 90, adjust a flush sequence, force a membrane flush, drain the tank, adjust tank pressure, or turn the system off. This information and control is optionally available through a GUI on a phone app or on a web browser dashboard.

A first TDS sensor 108 is optionally connected to the water feed line 96 to gauge the suspended particles in the incoming, untreated water. Next, the water feed line 96 is connected to a combined pre-filter and activated carbon filter 110. An optional flow sensor 112 is next connected to the water feed line 96. Between the flow sensor 112 and an RO unit 114 along the water feed line 96, is connected a permeate flush loop of conduit 116 controlled by a second solenoid valve 118. A second end 120 of the flush loop 116 is connected to the water feed line 96 downstream of a second TDS sensor 122, a pretank filter 124 and a check valve 126, each connected sequentially to the water feed line downstream of the RO unit 114. The second TDS sensor 122 is useful in monitoring the effectiveness of the RO unit in filtering the water.

Downstream of the second end 120 of the flush loop 116, the water feed line 96 passes to an RO storage tank 128 that stores water treated by the RO unit 114. A second pressure sensor 130 is connected to the water feed line 96 just upstream of the RO storage tank 128. A faucet feed line 132 is connected to the water feed line 96 between the second pressure sensor 130 and the second end 120 of the flush loop 116, and receives treated water from the RO storage tank 128. A second flow sensor 134 monitors flow to the faucet 74, 92. Also, a post filter 136 is connected to the faucet feed line 132 prior to a connection with the faucet 74, 92.

As is known in the art, the RO unit 114 removes particles from the incoming water through the use of an RO membrane 138. The collected retentate is sent to drain via a drain line 140. An optional fast flush loop 142 is connected to the drain line 140, and is under the control of a third solenoid valve 144. A capillary control valve 146 is placed in the drain line 140.

In the preferred embodiment, all of the solenoid valves 100, 118, 144 as well as the sensors 98, 108, 112, 122, 130 and 134 are connected to the control module 102, either by wired or wireless connection as is well known in the art. Depending on the programming of the processor 104 and the arrangement of the GUI 106, the system 90 is adjustable by the user to accommodate various base water quality characteristics, treated water demands, as well as desired water quality or water treatment system parameters.

While a particular embodiment of the present reverse osmosis drinking water system with dedicated powered faucet has been described herein, it will be appreciated by those skilled in the art that changes and modifications may be made thereto without departing from the invention in its broader aspects and as set forth in the following claims.

1. An air gap adapter for use with a water treatment faucet constructed and arranged for being mounted in a standard countertop faucet opening, said adapter comprising:
an adapter base with an underside, defining a base throughbore for a standard faucet inlet nipple, having an RO retentate inlet port and a separate RO retentate outlet port;
a cone insert having a platform covering at least a portion of said adapter base;
a cone formation vertically projecting from said platform and being in fluid communication with said inlet port;
an outlet opening on said cone formation in fluid communication with said RO retentate outlet port; and
an adapter cover disposed over said cone formation and said base includes a cone cover portion and a base cover portion, as well as a cover throughbore in registry with said base throughbore;
said adapter constructed and arranged to be optionally mounted to a countertop with said faucet.

2. The air gap adapter of claim 1, wherein said inlet port having an associated inlet flow channel, and said outlet port having an associated outlet flow channel in said adapter base.

3. The air gap adapter of claim 2, wherein said cone insert platform covers said inlet flow channel and said outlet flow channel.

4. The air gap adapter of claim 1, further including a flow directing formation on an exterior of said cone formation in fluid communication with an outlet opening in said cone formation and also with an outlet flow channel.

5. An air gap adapter for use with a water treatment faucet constructed and arranged for being mounted in a standard countertop faucet opening, said adapter comprising:
an adapter base with an underside, defining a base throughbore for a standard faucet inlet nipple, having an RO retentate inlet port and a separate RO retentate outlet port;
said inlet port having an associated inlet flow channel, and said outlet port having an associated outlet flow channel in said adapter base;
a cone insert having a platform covering at least a portion of said adapter base including said inlet flow channel and said outlet flow channel;
a cone formation vertically projecting from said platform and being in fluid communication with said inlet flow channel;
a flow directing formation on an exterior of said cone formation in fluid communication with an outlet opening in said cone formation and also with said outlet flow channel; and
an adapter cover including a cone cover portion and a base cover portion, as well as a cover throughbore in registry with said base throughbore.

6. The air gap adapter of claim 5, further including a seal configured for isolating said inlet flow channel from said outlet flow channel.

7. The air gap adapter of claim 5, further including a seal isolating said flow directing formation from said platform.

8. The air gap adapter of claim 5, wherein said adapter cover includes a depending skirt for enveloping a peripheral edge of said base.

9. The air gap adapter of claim 5, wherein said RO retentate inlet port has a shorter axial length than said RO retentate outlet port.

10. The air gap adapter of claim 5, wherein said inlet channel is adjacent said outlet flow channel in said base.

11. A water treatment faucet configured for use with a standard water faucet mounted in operational relationship to a sink and located on a countertop, said water treatment faucet comprising:
a faucet base configured for mounting to the countertop, and having a first electrical connector connected to a remote power source, and a second electrical connector connected to a water treatment system located underneath the countertop;
said first electrical connector being electrically connected to said second electrical connector.

12. The water treatment faucet of claim 11, wherein said first electrical connector is a primary induction coil; and said second electrical connector is a secondary induction coil located in operational proximity to said primary induction coil.

13. The water treatment faucet of claim 11, wherein said first electrical connector is directly electrically connected to said second electrical connector.

14. A water treatment system, including at least one prefilters, at least one RO membrane unit and a treated water storage tank, all of the above being connected by a water feed line, said system comprising:
at least one solenoid valve being connected between an inlet and at least one of said at least one filters, said at least one RO membrane unit and said a storage tank for controlling flow in said water feed line.

15. The water treatment system of claim 14, wherein said at least one solenoid valve includes a first solenoid valve connected to said water feed line before said at least one prefilter.

16. The water treatment system of claim 14, wherein said at least one solenoid valve includes a second solenoid valve connected to said water feed line between said at least one prefilters and said at least one RO membrane unit.

17. The water treatment system of claim 16, wherein said second solenoid valve has an inlet connected to said water feed line between said at least on prefilter and said at least one RO membrane unit, and a solenoid valve outlet connected to said water feed line between said at least RO membrane unit and said RO storage tank.

18. The water treatment system of claim 17, further including a pretank filter connected to said water feed line between said at least one RO membrane unit and said second solenoid valve outlet.

19. The water treatment system of claim 14, wherein said at least one solenoid valve includes a third solenoid valve connected to a drain line connected to said at least one RO membrane unit.
